(19) United States
(12) Patent Application Publication
(10) Pub. No.: US 2007/0231213 A1
(43) Pub. Date: Oct. 4, 2007

(54) SMART NANO-INTEGRATED SYSTEM ASSEMBLY

(75) Inventors: Vinayak Ashok PRABHU, Singapore (SG); Hui Yng Ong, Singapore (SG); Teck Boon Steven Yap, Singapore (SG); Eng Hoo Teddy Ong, Singapore (SG)

Correspondence Address: LAWRENCE Y.D. HO & ASSOCIATES PTE LTD, 30 BIDEFORD ROAD, #02-02, THONGSIA BUILDING, SINGAPORE, 229922, SG

(73) Assignee: NANYANG POLYTECHNIC, Singapore (SG)

(21) Appl. No.: 11/538,053

(22) Filed: Oct. 2, 2006

(30) Foreign Application Priority Data
Jan. 12, 2006 (SG) 200600303-2

(51) Int. Cl. B01L 3/02

(52) U.S. Cl. 422/100

(57) ABSTRACT

The present invention provides a nano-integrated system assembly that offers both convenience and cost-efficiency, where multiple fluidic, electronic and mechanical components or chemical processes are optimally embraced effectively and efficiently in a systematic modularized manner. Furthermore, the nano-integrated system assembly has a generic configuration so as to enable and accommodate a wide spectrum of differently combined sequences of analyzing/processing operations to be performed on the identical nano-integrated system assembly.

### FIELD OF THE INVENTION

The present invention generally relates to microfluidic devices, and more particularly to a nano-integrated system assembly that has a modular architecture comprising a microfluidic chip, an intermediate control module, and a master control module. The nano-integrated system assembly is versatile in analyzing/processing fluidic samples, especially biological samples.

### BACKGROUND OF THE INVENTION

Microfluidic technology has been applied broadly to chemical and biomedical applications. Microfluidic devices offer distinctive advantages of low manufacturing cost, high throughput, minimal reagent consumption, and high degree of automatability. Another advantage is that multiple operations can be performed simultaneously on a single microfluidic module.

Microfluidic devices are extensively explored for their applications in biomedical operations, especially in these circumstances where multiple operations are required for performing analysis/processing either sequentially or in parallel. For instance, identifying a target DNA sequence within a biological sample is very crucial in a large number of fields such as clinical diagnostics, forensic medicine, research, military applications, food and water testing, homeland security and drug development. With traditional DNA-analysis apparatuses, the identification of a target DNA sequence requires isolation of DNA samples with a DNA isolation kit, amplification of the target DNA sequence by PCR with a tabletop PCR machine, and hybridization/sequencing to confirm the identity of the target DNA sequence with a tabletop hybridization/sequencing apparatus. It is apparent that these traditional apparatuses are not satisfactory as demand increases for more genetic information to be found and mined in shorter time and at lower costs.

Furthermore, most of analyzing tests are better done on site where laboratory access is not possible. Currently, separate instruments are used at each stage, and manual steps are needed. Some of these instruments are bulky and require pre-processing stages based on manual laboratory monotonous and repetitive work performed by staff with sufficiently good technical expertise. Even though automation has played a major role in increasing the throughput and improving the reliability of the process, the instruments are still designed only for specific use within a laboratory environment.

Currently available microfluidic devices have been designed to emphasize on either convenience or cost-efficiency. For example, U.S. Pat. No. 6,830,936 discloses a miniaturized integrated nucleic acid diagnostic device that can integrate several or all of the operations involved in sample acquisition and storage, sample preparation and sample analysis within a single integrated unit. However, the microfluidic chip disclosed therein integrates fluidic channels and chambers, and electronic components such as detection sensors, heaters or voltage sources into one chip unit. It is apparent that this device is very convenient, but not cost effective as a disposable unit.

On the other end of the integration scale lie devices with no functionality built onto the microfluidic devices, and the microfluidic devices completely depend on externally and commercially available components and equipments to perform the desired operation. It is apparent that this design offers cost-saving, but is not convenient.

### SUMMARY OF THE INVENTION

Therefore, one of the objectives of the present invention is to provide a nano-integrated system assembly that offers both convenience and cost-efficiency, where multiple fluidic, electronic and mechanical components or chemical processes are optimally embraced effectively and efficiently in a systematic modularized manner.

Another objective is to provide a nano-integrated system assembly that has a generic configuration so as to enable and accommodate a wide spectrum of differently combined sequences of analyzing/processing operations to be performed inside microfluidic wells with enhanced efficiency using magnetic nanoparticles on the identical nano-integrated system assembly.

In one aspect of the present invention, there is provided a smart nano-integrated system assembly for automated analysis in a fluidic format of a sample. In one embodiment, the smart nano-integrated system assembly comprises a microfluidic analysis chip having microfluidic wells for receiving reagent solutions and allowing different reactions within the wells, and microfluidic channels for connecting the wells so as to allow a series of reactions to be performed in a chain-reaction manner; an intermediate control module being disposed underneath of the microfluidic analysis chip; wherein the intermediate control module has an embedded functional circuitry for controlling the reaction parameters in each well and the passage conditions in each channel within the microfluidic chip; and a master control module being disposed underneath of the intermediate control module; wherein the master control module has an embedded electronic circuitry for inputting commanding signals to the intermediate control module.

In another embodiment of the smart nano-integrated system assembly, the microfluidic wells within the microfluidic analysis chip are arranged in an array format so that parallel operations can be performed. In yet another embodiment of the smart nano-integrated system assembly, the microfluidic wells within the microfluidic analysis chip is arranged in a predefined format so that a specific application can be performed. In yet still another embodiment of the smart nano-integrated system assembly, the functional circuitry embedded within the intermediate control module comprises a plurality of functional control units; and wherein each unit controls a corresponding well of the microfluidic chip. In one further embodiment of the smart nano-integrated system assembly, each of the functional control units comprises at least one microheater, at least one magnetic field sensor, at least one set of magnetic nanoparticle manipulation circuits, at least one micropump actuation interface, a thermal boundary, at least one temperature sensor, and at least one electrical interconnect for general applications. In another further embodiment of the smart nano-integrated system assembly, each of the functional control units comprises one or more of the following components including microheater, magnetic field sensor, at least one set of magnetic nanoparticle manipulation circuits, micropump actuation interface, thermal boundary, temperature sensor, and electrical interconnect for specific applications.

In another aspect of the present invention, there is provided a miniature automated system for biomedical analysis. In one embodiment, the miniature automated system comprises a microprocessor; a smart nano-integrated system assembly comprising: a microfluidic analysis chip having microfluidic wells for receiving reagent solutions and allowing different reactions within the wells, and microfluidic channels for connecting the wells so as to allow a series of reactions to be performed in a chain-reaction manner; an intermediate control module being disposed underneath of the microfluidic analysis chip; wherein the intermediate control module has an embedded functional circuitry for controlling the reaction parameters in each well and the passage conditions in each channel within the microfluidic chip; and a master control module being disposed underneath of the intermediate control module; wherein the master control module has an embedded electronic circuitry for inputting commanding signals to the intermediate control module.

In another embodiment of the miniature automated system, the microprocessor is selected from the group consisting of PDA, PC, or any electronic input and output devices. In yet another embodiment of the miniature automated system, the microfluidic wells within the microfluidic analysis chip are arranged in an array format so that parallel operations can be performed. In still another embodiment of the miniature automated system, the microfluidic wells within the microfluidic analysis chip are arranged in a predefined format so that a specific application can be performed. In yet still another embodiment of the miniature automated system, the functional circuitry embedded within the intermediate control module comprises a plurality of functional control units; and wherein each unit controls a corresponding well of the microfluidic chip. In one further embodiment of the miniature automated system, each of the functional control units comprises at least one microheater, at least one magnetic field sensor, at least one micropump actuation interface, a thermal boundary, at least one temperature sensor, and at least one electrical interconnect for general applications. In another further embodiment of the miniature automated system, each of the functional control units comprises one or more of the following components including microheater, magnetic field sensor, at least one set of magnetic nanoparticle manipulation circuits, micropump actuation interface, thermal boundary, temperature sensor, and electrical interconnect for specific applications.

The objectives and advantages of the invention will become apparent from the following detailed description of preferred embodiments thereof in connection with the accompanying drawings.

### BRIEF DESCRIPTION OF THE DRAWINGS

Preferred embodiments according to the present invention will now be described with reference to the Figures, in which like reference numerals denote like elements.

FIG. 1 is a functional block diagram of the architecture of the nano-integrated system assembly in accordance with one embodiment of the present invention.

FIG. 2 shows a schematic view of a generic intermediate control module (ICM) comprising of a plurality of Functional Control Units (FCU) in accordance with one embodiment of the present invention.

FIG. 3 shows an illustratively schematic view of an FCU for performing DNA manipulations in accordance with one embodiment of the present invention.

FIG. 4 shows a schematic view of an application-specific ICM in accordance with one embodiment of the present invention.

FIG. 5 shows a plan view of schematic view of the microfluidic chip with parallel processes of two samples in accordance with one embodiment of the present invention.

FIG. 6 shows an illustratively schematic view of one reaction chamber with its surroundings in accordance with one embodiment of the present invention.

FIG. 7 shows another illustratively schematic view of the microfluidic chip with parallel processes of four samples in accordance with one embodiment of the present invention.

FIG. 8 shows a schematic view of an integrated application-specific microfluidic chip in accordance with one embodiment of present invention.

### DETAILED DESCRIPTION OF THE INVENTION

The present invention may be understood more readily with reference to the following detailed description of certain embodiments of the invention.

Throughout this application, where publications are referenced, the disclosures of these publications are hereby incorporated by reference, in their entireties, into this application in order to more fully describe the state of art to which this invention pertains.

In the following detailed description, specific details are set forth in order to provide a thorough understanding of the invention. However, it will be understood by those skilled in the relevant art that the present invention may be practiced without these specific details. In other instances, well-known methods, procedures, components, and materials have not been described in detail so as not to obscure the present invention.

The nano-integrated system assembly of the present invention modularizes microfluidic and functional control components so that it offers both convenience and cost-efficiency. The modularized nano-integrated system assembly automatically analyzes fluidic samples by performing a sequence of reactions.

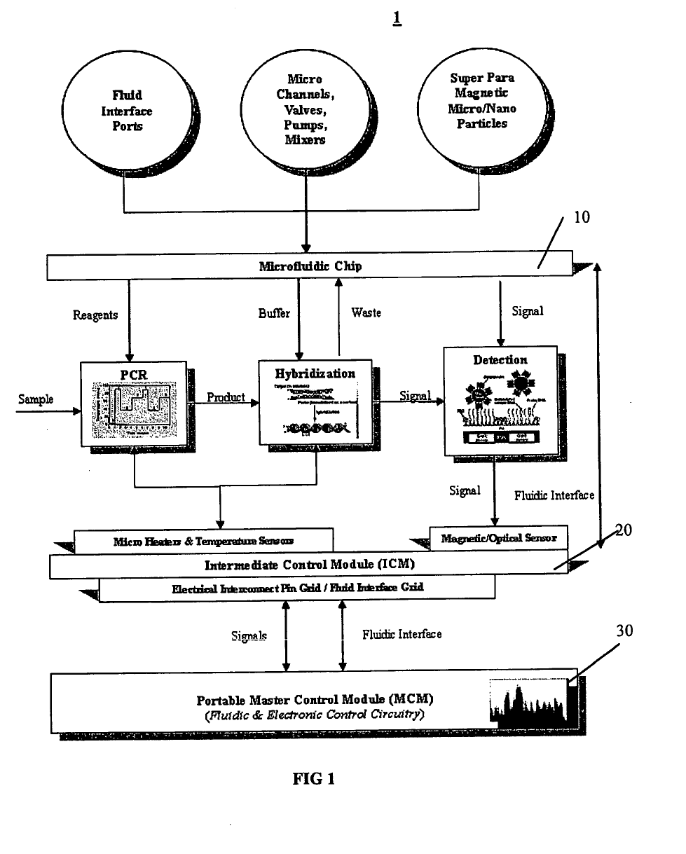

Now referring to FIG. 1, there is provided a functional block diagram of the architecture of the nano-integrated system assembly in accordance with one embodiment of the present invention. As shown in FIG. 1, the smart nano-integrated system assembly 1 comprises a microfluidic chip 10, an intermediate control module (ICM) 20, and a master control module 30. Each layer is functionally specific and physically differentiated from the other layers. This functional stack when activated performs a particular biological procedure as per programmed where each layer works interdependently with the others through the corresponding respective electrical and fluidic interconnections controlled electronically.

Intermediate Control Module (ICM) 20

The ICM 20 as denoted by its name designation is the middle layer of the smart nano-integrated system assembly serving as the interface between the microfluidic chip 10 and the master control module 30. Preferably, the ICM 20 houses all the active electronic/magnetic components that are required to perform the desired operational processes in the microfluidic chip 10 under programmed control. In some circumstances, some of the active electronic/magnetic components may be embedded within the substrate of the microfluidic chip 10. It may be particularly desirable when some specific applications are performed. For the present invention, the ICM can be configured and customized to accommodate many different variants requirements. The following specific configurations of the ICM are provided for the sole purpose of illustrating the principles of the present invention.

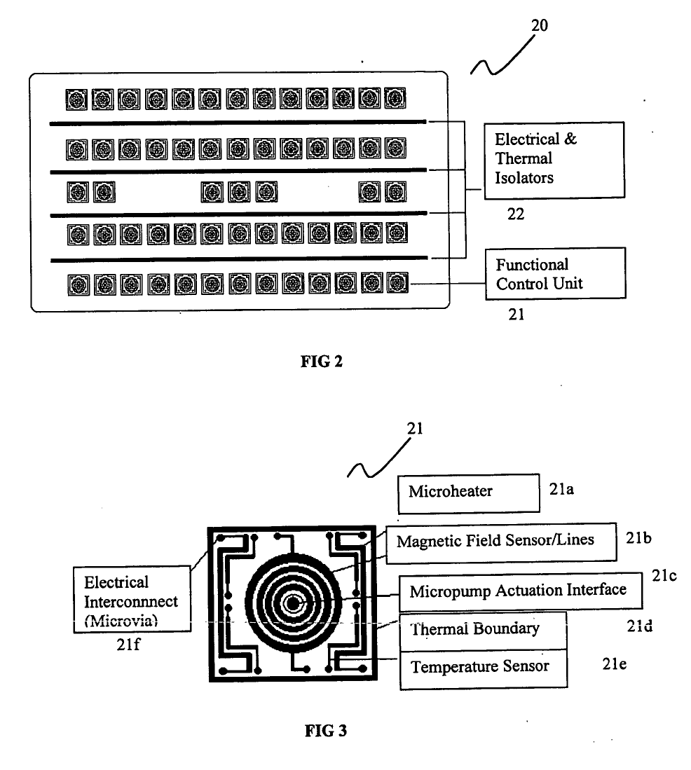

In one embodiment, the ICM 20 may be a generic platform for it enables the microfluidic chip 10 to perform multiple reactions simultaneously. FIG. 2 shows a plan view of the ICM 20 comprising a plurality of a Functional Control Unit (FCU) in accordance with one embodiment of the present invention. As shown in FIG. 2, the FCUs 21 can be arranged into an array format. The center row of the generic microfluidic chip comprises of self/auto-calibration sites and positive/negative control sites. The two FCUs on either ends correspond to the said control sites governing the top two and bottom two rows of reaction sites and the middle three FCUs correspond to the said self/auto-calibration sites. It is to be appreciated that the FCUs can be arranged in any other suitable configurations deemed necessary or appropriate to execute its intended function. The ICM 20 further comprises a plurality of thermal and electrical isolators both in-plane and normal to the plane of the plan view of the microfluidic chip 22 that are interposed between two rows of FCUs. Isolators are deployed to eliminate or minimize any potential occurrence of crosstalk phenomenon.

As for a generic ICM, each FCU may comprise substantially similar, unique or identical electronic/magnetic components so that every FCU within the ICM has the capacity of performing all possible functions that are required for performing all possible reactions within the microfluidic chip. For example, when the microfluidic chip is designed for a sequence of biological reactions including DNA isolation, PCR amplification of the isolated DNA, and hybridization of the amplified PCR products, it requires mixing of samples in wells, transferring samples from one well to another, rapid heating/cooling during PCR reactions, and maintaining appropriate temperatures during PCR extension and hybridization. FIG. 3 shows an illustratively schematic view of a FCU for performing such DNA manipulations in accordance with one embodiment of the present invention. The FCU as shown in FIG. 3 comprises at least one microheater 21a, at least one magnetic field sensor 21b, at least one micropump actuation interface 21c, a thermal boundary 21d, at least one temperature sensor 21e, and at least one electrical interconnect (microvia) 21f. The configuration of all the components and the number of each component within each FCU are determined by the specific requirements for actual applications.

Referring still to FIG. 3, the FCU is a discrete unit comprising sensing and control components within a thermally confined zone. The thermally-confined zone forms the boundary of the FCU and aligns with the respective relevant reaction site on the microfluidic chip when assembled. In one embodiment, the thermal boundary 21d is a metallic frame that sits in a groove etched on the substrate. The thermal boundary encloses the functional components of each FCU.

Temperature control is critical for many reactions. Each FCU controls the temperature within the thermal boundary 21d using at one least one microheater 21a and at least one temperature sensor 21e controlled by feedback servo loop. The suitable feedback means are well known to those skilled in the art. In one embodiment, as shown in FIG. 3, four temperature sensors 21e are placed on the four diagonal sections in close proximity to four microheaters 21a. The magnetic field sensor 21b may be a coil of appropriate conductor that can detect minute changes in the magnetic field due to interaction of magnetic particles with local magnetic field lines inside the microfluidic reactor. These magnetic field lines may also be utilized in a different configuration for manipulation of magnetic nanoparticles within the microfluidic wells for mixing or analyzing purposes. In one embodiment, as shown in FIG. 3, the magnetic sensor is centrally located inside the FCU.

Temperatures sensors, microheaters and the magnetic sensor are connected to voltage/current pin contacts such as on the bottom side of the ICM using through-substrate interconnect vias. These conducting vias provide/receive electrical signals to and from the master control module. This configuration optimizes the real estate usage on the ICM and also provides shortest connection pathways to eliminate and/or minimize any signal losses.

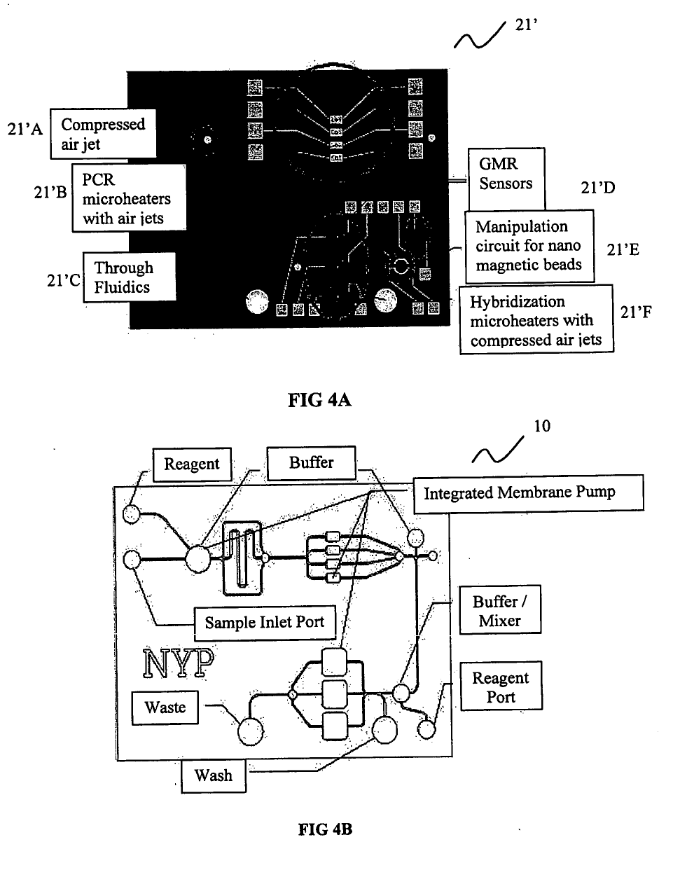

In another embodiment, the ICM may be an application-specific platform 20′ for it enables an individually unique microfluidic chip to perform a specified application. The application-specific ICM has its Functional Control Elements (FCEs) 21′ disposed over its surface according to predetermined locations and is not arrayed as in the generic ICM. For the terminology, it is to be noted that an FCU comprises Functional Control Elements (FCEs) such as but not limited to microheaters, temperature sensors and magnetic field sensors. In the application-specific ICM, these FCEs are specifically and uniquely positioned to perform their individual user-defined task operations and may not necessarily be grouped into FCUs as in the case of a generic ICM. In this case, the layout of the microfluidic reactors within the microfluidic chip dictates the layout of the FCUs of the ICM whereas the generic ICM layout supports the layouts of different microfluidic chips. As shown in FIG. 4A, an application-specific ICM 21′ is provided for PCR amplification of DNA and hybridization. Each of the FCEs 21′ is capable of performing certain defined functions. For example, FIG. 4A shows compressed air jet 21′A, PCR microheaters with air jets 21′B, through fluidics 21′C, GMR sensors 21′D, circuit for nano magnetic bead manipulation 21′E, and hybridization microheaters with compressed air jets 21′F. It is evident that all the FCEs are not arrayed; instead, they are arranged in a specific ordered manner so as to perform the two reactions in continuity. As shown in FIG. 4B, in the application-specific microfluidic chip, each reactor is designed to perform its own unique programmed operation. Hence for the PCR reactor site, the corresponding FCEs are microheaters and temperature sensors whereas for the microarray reactor sites, they are all under a common heat zone (consisting of arrays of microheaters) but each reactor site has its own FCE in the form of a magnetic field sensor for high accuracy.

Microfluidic Chip

The microfluidic chip 10 contains sample/reagent handling and control means and provides microenvironments for different analyzing/processing operations. Briefly, the microfluidic chip 10 is a polymer-based one that comprises a plurality of micro-reaction chambers for housing different operations and a fluidic network serving the plurality of micro-reaction chambers. The micro-reaction chambers are configured on the microfluidic chip so as to align to the unique configuration of FCUs on the ICM; each micro-reaction chamber is served by one FCU wherein the ICM and microfluidic chip are assembled into the nano-integrated system assembly. The fluidic network comprises a plurality of sealable fluid inlet ports for introduction of fluidic samples to be analyzed/processed into the plurality of micro-reaction chambers, a plurality of sealable fluid outlet ports for outputting of the analyzed/processed fluidic samples from the plurality of micro-reaction chambers, a plurality of microfluidic channels for fluid transport, a plurality of passive microvalves disposed at the inlet and outlet of each reaction chamber for flow control, and a plurality of membrane actuated push-flow means that are activated by appropriate actuators such as but not limited to mechanical or pneumatic solenoids actuated in a to and fro motion. The base of the micro-reaction chambers is made into a thin membrane. This membrane serves two purposes. First, due to its small thickness, it provides minimal thermal resistance and magnetic interference. Second, after the reaction is completed, it can be actuated by the solenoid to displace fluids out of the chamber into the outlet channels for collection or further downstream analysis.

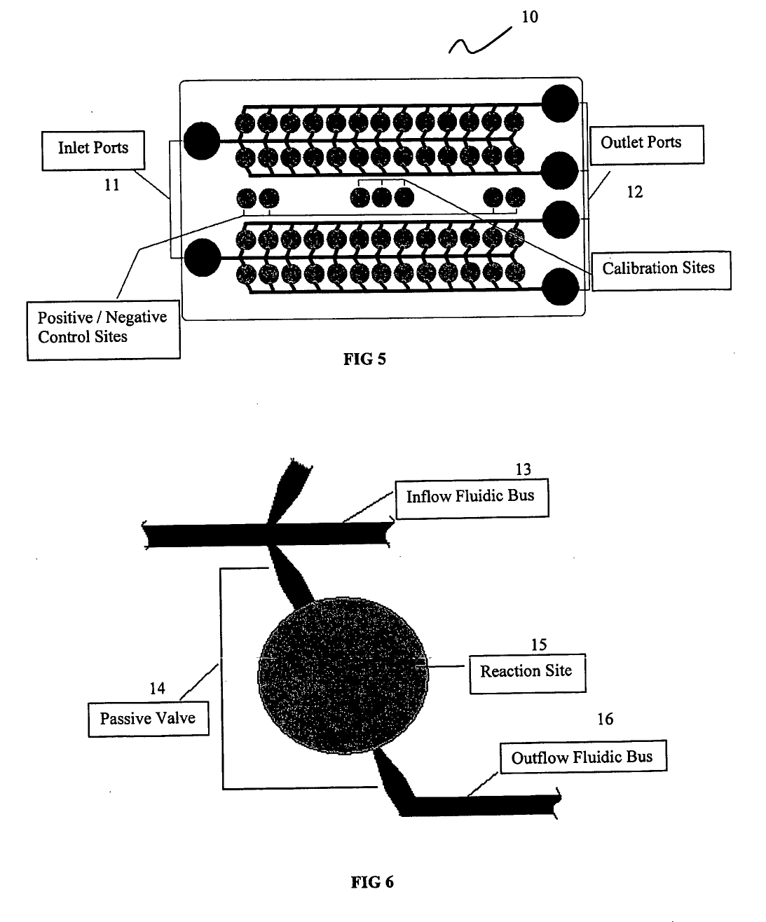

Now referring to FIG. 5, there is provided an exemplary microfluidic chip in accordance with one embodiment of the present invention. As shown in FIG. 5, the microfluidic chip 10 comprises two fluid inlet ports 11 for being able to analyze/process two samples concurrently. It further comprises a plurality of micro-reaction chambers, positive/negative control chambers, and calibration chambers. It further comprises two inflow fluidic buses 13 of which each being fluidicly connected with each fluid inlet port; four outflow fluidic buses 16 of which each being fluidicly connected with one fluid outlet port 12, and a plurality of microfluidic channels fluidicly connecting each micro-reaction chamber 15 with the inflow/outflow fluidic buses. As shown in FIG. 6, each micro-reaction chamber 15 is connected to the inflow fluidic bus 13 via a passive valve 14 and the outflow fluidic bus 16 via a passive valve 14.

As an illustration, the microfluidic chip as shown in FIG. 5 provides a generic platform for high throughput DNA microarray analysis as well as for high throughput real-time PCR. For high throughput DNA microarray assay, each of the micro-reaction chambers is pre-spotted with appropriate cDNA or Oligonucleotide probes; it forms a DNA microarray. After the pre-spotted micro-reaction chambers are blocked, fluidic samples can be introduced into one of the inflow fluidic bus via one of the fluid inlet ports. Then, the fluidic sample will be introduced into each of the micro-reaction chambers and hybridization can be conducted within each micro-reaction chamber using the appropriate reagents and maintaining the required temperature control in each of the reaction chambers by the FCUs. After hybridization, the micro-reaction chambers can be washed to eliminate all possible non-specific binding and then specific binding to each probe is detected through optical, magnetic or other appropriate means. Magnetic sensing of hybridization is performed by detection of tagged magnetic nanoparticles within double stranded DNA spots using magnetic field sensors on the appropriate assembly within the FCU on the ICC. For performing high throughput real-time PCR, each micro-reaction chamber performs one PCR reaction that is controlled by its corresponding FCU of the ICM. Because each individual FCU can be configured uniquely to operate its own thermal cycle independent of the ones adjacent to it, real-time curve of PCR reactions within different micro-reaction chambers can be achieved. In addition, there is minimum or zero thermal crosstalk between adjacent chambers, thereby reducing or eliminating all possible errors.

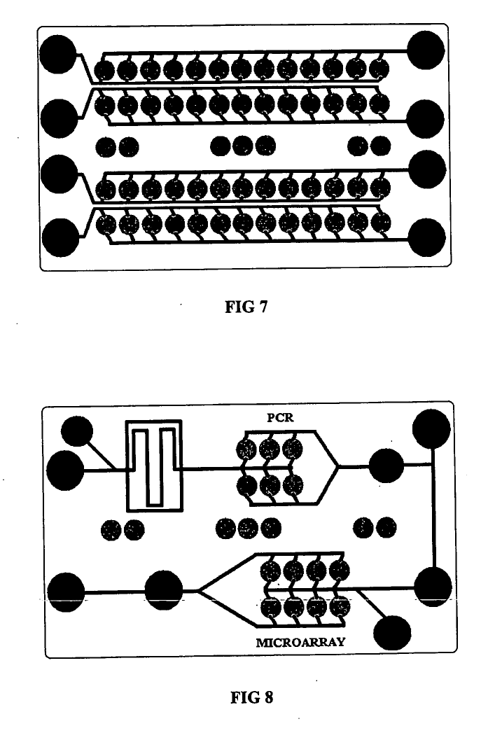

Now referring to FIG. 7, there is provided another exemplary microfluidic chip in accordance with one embodiment of the present invention. The microfluidic chip as shown in FIG. 7 has the same array of micro-reaction chambers as shown in FIG. 5, but the addition of two inflow fluidic buses and two fluid inlet ports enables it to analyze/process four samples in parallel. It is to be appreciated that the microfluidic chip can be configured according to one's application while using the same ICM.

Similarly to the ICM, the microfluidic chip is also configurable to perform a selected sequence of operations. For example, as shown in FIG. 8, the microfluidic chip can be customized to low throughput integrated system where sample preparation, DNA amplification using PCR, detection using capillary electrophoresis and DNA microarray analysis can all be performed on a single reactor chip. This microfluidic chip has its reaction chambers aligned to individual corresponding respective FCUs in the ICM. The only difference is that only the FCUs serving the reaction chambers will be activated and controlled. The others will remain inactivated and not in use. In this way, both analysis throughput and analysis type can be customized using the same ICM. This enables the system to be highly cost effective and adaptable to various applications being catered to by simply replacing custom made application-specific or generic microfluidic chips. In addition these chips are disposable and would be designed for low cost usage.

Master Control Module

The master control module interfaces with the ICM for transmitting and receiving of electrical and biosignals following a uniform standard protocol irrespective of the ICM format or the microfluidic chip layout. The ICM on its bottom face consists of a grid of electrical and pump actuation pins/interfaces through interconnect microvias. This grid is arranged in a uniform array to provide a generic signal relay to the master control module. This configuration allows for progranmed on/off of particular pins/interfaces to a standard master control interface according to the application served by the ICM.

Mixing of binary or multi-component fluid streams can be difficult in microchannels where the flow is laminar under normal conditions. Therefore, mixing relies mainly on diffusion. For a typical microfluidic device, the length scale is too large for rapid diffusion and too small to include mechanical agitation. The mixing may be achieved in two ways. One may utilize the magnetic nanoparticles as mixing or assaying agents due to their inherent bio-chemical and magnetic behavior. This invention incorporates magnetic beads for effective mixing. Before the reactions take place, the participating fluids are driven to a buffer reservoir containing nano magnetic beads. Motion is then induced in the beads causing an artificial turbulence thereby facilitating effective mixing.

Another way for effective mixing is the introduction of a high performance passive mixer. It is possible to achieve static mixing by geometrically splitting and recombining fluid sub-streams. In this way, large contact surfaces and small diffusion paths are generated. The shape of a passive mixer may be simulated and optimized using a computational fluid dynamic (CFD) analyzer for microfluidics.

Manufacture

The nano-integrated system assembly can be manufactured by known techniques. For example, finite element modeling (FEM) and computational fluid dynamic (CFD) analyses can be carried out to determine the optimal geometries in the microfluidic chip, namely the microchannels, passive microvalves, wells, reaction chambers, and passive mixer. CFD may be used to study the influence of geometric parameters on passive mixing characteristics. Thermal analysis by the CFD can be used to optimize the location and geometry of the heaters and achieve temperature uniformity over the reaction chambers.

The nano-integrated system assembly would be a hybrid mix of different construction materials, processes and manufacturing techniques. The suitable materials include but are not limited to silicone elastomers, stereolithography resins, cyclic olefin copolymer (COC), polycarbonate (PC), poly methyl methacrylate (PMMA), polyimide, silicon, epoxy laminate and glass.

The specialized polymer BioMEMS processes used could be one or a combination of soft lithography, stereolithography, micro injection molding, hot embossing, silicon surface and bulk micromachining, glass micromachining, laser micromachining and printed circuit board machining.

The advantages of the nano-integrated system assembly of the present invention include: (i) reducing the sensor element to the scale of the target species and hence providing a higher sensitivity; (ii) reduced reagent volumes and associated costs; (iii) reduced time to result due to small volumes resulting in higher effective concentrations; and (iv) amenability of portability and miniaturization of the entire system.

The biological and biomedical applications of micro and nanotechnology (commonly referred to as Biomedical/Biological Micro-Electro-Mechanical Systems, BioMEMS) have become increasingly prevalent and have found widespread important and effective use in a broad spectrum of applications such as diagnostics, therapeutics, and tissue engineering. BioMEMS for diagnostic applications are sometimes referred to as biochips. These devices are used to detect cells, microorganisms, viruses, proteins, DNA and related nucleic acids, and small molecules of biochemical importance and interest.

The nano-integrated system assembly of the present invention can be employed in applications including, but not limited to, in-vitro molecular diagnostics (DNA based assays, single-nucleotide polymorphism analysis), in-vitro medical diagnostics (pathogen detection in whole blood), drug discovery, portable water and food analysis, forensic applications, environmental, food safety, and homeland security applications involved in the detection of bacterial pathogens. For example, with the integration of PCR amplification into automated processes, the nano-integrated system assembly is suitable for field, point-of-care and agricultural applications including the detection of gene-modified foods and pathogens. More importantly, the nano-integrated system assembly of the present invention may be developed into small, rapid hand-held devices that can be used by minimally trained personnel especially for the military field deployment purpose and interest in the detection of bio-warfare agents such as smallpox, anthrax, plague, viral hemorrhagic fevers (Ebola virus, Marburg virus), Brucella spp. (brucellosis), and Burkholdaria spp.

While the present invention has been described with reference to particular embodiments, it is understood that the embodiments are illustrative and that the invention scope is not so limited as such. Alternative embodiments of the present invention will become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

What is claimed is:

1. A smart nano-integrated system assembly for automated analysis in a fluidic format of a sample, comprising:
a microfluidic analysis chip having microfluidic wells for receiving reagent solutions and allowing different reactions within the wells, and microfluidic channels for connecting the wells so as to allow a series of reactions to be performed in a chain-reaction manner;
an intermediate control module being disposed underneath of the microfluidic analysis chip; wherein the intermediate control module has an embedded functional circuitry for controlling the reaction parameters in each well and the passage conditions in each channel within the microfluidic chip; and
a master control module being disposed underneath of the intermediate control module; wherein the master control module has an embedded electronic circuitry for inputting commanding signals to the intermediate control module.

2. The smart nano-integrated system assembly of claim 1, wherein the microfluidic wells within the microfluidic analysis chip is arranged in an array format so that parallel operations can be performed.

3. The smart nano-integrated system assembly of claim 1, wherein the microfluidic wells within the microfluidic analysis chip is arranged in a predefined format so that a specific application can be performed.

4. The smart nano-integrated system assembly of claim 1, further comprising a microfluidic mixing sub system that is configurable into a geometric split-and-combine passive mixer or in-situ mixing within the reaction wells itself using nanoparticles electrically manipulated to create artificial turbulence in the fluid stream thereby causing the fluids to mix.

5. The smart nano-integrated system assembly of claim 1, wherein the functional circuitry embedded within the intermediate control module comprises a plurality of functional control units; and wherein each unit controls a corresponding well of the microfluidic chip.

6. The smart nano-integrated system assembly of claim 4, wherein each of the functional control units comprises at least one microheater, at least one magnetic field sensor, at least one set of magnetic nanoparticle manipulation circuits, at least one micropump actuation interface, a thermal boundary, at least one temperature sensor, and at least one electrical interconnect for general applications.

7. The smart nano-integrated system assembly of claim 4, wherein each of the functional control units comprises one or more of the following components including microheater, magnetic field sensor, magnetic nanoparticle manipulation circuit, micropump actuation interface, thermal boundary, temperature sensor, and electrical interconnect for specific applications.

8. A miniature automated system for biomedical analysis, comprising:
a microprocessor;
a smart nano-integrated system assembly comprising:
a microfluidic analysis chip having microfluidic wells for receiving reagent solutions and allowing different reactions within the wells, and microfluidic channels for connecting the wells so as to allow a series of reactions to be performed in a chain-reaction manner;
an intermediate control module being disposed underneath of the microfluidic analysis chip; wherein the intermediate control module has an embedded functional circuitry for controlling the reaction parameters in each well and the passage conditions in each channel within the microfluidic chip; and
a master control module being disposed underneath of the intermediate control module; wherein the master control module has an embedded electronic circuitry for inputting commanding signals to the intermediate control module.

9. The miniature automated system of claim 7, wherein the microprocessor is selected from the group consisting of PDA, PC, or any electronic input and output devices.

10. The miniature automated system of claim 7, wherein the microfluidic wells within the microfluidic analysis chip are arranged in an array format so that parallel operations can be performed.

11. The miniature automated system of claim 7, wherein the microfluidic wells within the microfluidic analysis chip are arranged in a predefined format so that a specific application can be performed.

12. The miniature automated system of claim 7, wherein the functional circuitry embedded within the intermediate control module comprises a plurality of functional control units; and wherein each unit controls a corresponding well of the microfluidic chip.

13. The miniature automated system of claim 11, wherein each of the functional control units comprises at least one microheater, at least one magnetic field sensor, at least one set of magnetic nanoparticle manipulation circuits, at least one micropump actuation interface, a thermal boundary, at least one temperature sensor, and at least one electrical interconnect for general applications.

14. The miniature automated system of claim 11, wherein each of the functional control units comprises one or more of the following components including microheater, magnetic field sensor, magnetic nanoparticle manipulation circuit, micropump actuation interface, thermal boundary, temperature sensor, and electrical interconnect for specific applications.
